(19) United States
(12) Patent Application Publication
(10) Pub. No.: US 2007/0213471 A1
(43) Pub. Date: Sep. 13, 2007

(54) COMPOSITION AND METHOD OF USE

(75) Inventors: Sung Dug Kim, Newburgh, IN (US); Subir Debnath, Metairie, LA (US)

Correspondence Address: GEAM - O8CV - CPP;IP LEGAL, ONE PLASTICS AVENUE, PITTSFIELD, MA, 01201-3697, US

(73) Assignee: General Electric Company, Schenectady, NY (US)

(21) Appl. No.: 11/465,666

(22) Filed: Aug. 18, 2006

Related U.S. Application Data
(63) Continuation-in-part of application No. 11/371,794, filed on Mar. 9, 2006.

(51) Int. Cl. C08F 20/32; C08G 63/91

(52) U.S. Cl. 525/437; 525/438; 525/445

(57) ABSTRACT

An article for contact with a liquid fuel, comprising a composition comprising a polyester reacted with a carboxy-reactive material, the product of said reaction having increased solvent resistance relative to the initial polyester. The article can be in the form of a container or fibers.

### CROSS-REFERENCE TO RELATED APPLICATION

This application is a continuation-in-part of U.S. patent application Ser. No. 11/371,794, filed on Mar. 9, 2006, which is hereby incorporated by reference in its entirety.

### BACKGROUND OF THE INVENTION

Polyesters are well known in polymer chemistry for many decades. Among the properties for which polyesters are known are electrical, heat deflection temperature (HDT), flow rate, solvent resistance, and the like. When used in blends with the materials such as polycarbonates, impact modifiers and the like, it is usually the above-mentioned polyester properties which are sought after and improve such properties of the blend's other components.

We have now found that a polyester's, e.g., polybutylene terephthalate (PBT), basic properties of solvent resistance, particularly to that of an organic, oil based solvent such as gasoline, can be significantly improved when the polyester is contacted with a carboxy-reactive material, particularly a epoxide or an epoxy silane. The improvement in solvent resistance is maintained even when an alcohol is a component of a gasoline or a fuel.

### SUMMARY OF THE INVENTION

In accordance with the invention, there is a composition comprising a polyester reacted with an epoxide or an epoxy silane, the product of said reaction having better solvent resistance than the initial polyester.

In accordance with another embodiment, an article comprises a composition comprising the reaction product of a polyester and a carboxy-reactive material, wherein the composition has increased resistance to components of a liquid fuel relative to the same composition without the carboxy-reactive compound.

### DETAILED DESCRIPTION OF THE INVENTION

Many liquid fuels now contain various levels of alcohols, including C₁₋₆ alcohols. Solvent resistance to alcohol and such fuel systems is especially important to part performance and service life. It has unexpectedly been discovered by the inventors hereof that the solvent resistance of compositions comprising a polyester, in particular polybutylene terephthalate, can be significantly improved by the addition of a carboxy-reactive material. In a particularly advantageous feature, such compositions exhibit excellent resistance to liquid fuels containing alcohols, e.g., alcohols containing from 1 to 6 carbon atoms. The polyester compostions are therefore of particular utility in applications that come into contact with fuel, such as fuel containers and fibers used in fuel filters.

The singular forms “a”, “an”, and “the” include plural referents unless the context clearly dictates otherwise.

“Optional” or “optionally” as used herein means that the subsequently described event may or may not occur, and that the description includes instances where the event occurs and the instances where it does not occur.

All volume percents (volume % or vol. %) are calculated based on the additive volume of each component prior to mixing.

Any polyester can be the initial polyester provided it has carboxyl groups reactive with the carboxy-reactive compound, or carboxy and/or alcohol end groups available for reaction with the epoxy silane. Examples of such polyesters include PBT, polyethylene terephthalate (PET), polytrimethylene terephthalate (PTT), and reaction products of any other aromatic diacid polyester with any other diol, or codiol or co-diaromatic acid. Examples of polyester include but are not limited to isophthalic acid containing polyesters, polyethylene naphthalate, iso- and terephthalate containing polyesters, aliphatic diacid (such as succinic, citric, malic, and the like) containing polyesters, alone or with other aliphatic diacids, or together with an aromatic diacid containing polyesters. Various diols alone or mixtures of diols can be used as comonomers, such as trimethylene diol, pentane diol, and cycloaliphatic diols such as 1,4-cyclohexane dimethanol (CHDM). CHDM in particular can be used alone with terephthalic acid (TPA) (to provide a polyester abbreviated as PCT) or together with various quantities of butylene glycol or ethylene glycol (to provide a polyester abbreviated as PTG (more CHDM, less ethylene glycol (EG)), PETG (more EG, less CHDM), or combined with a cycloaliphatic diacid (cyclohexane dicarboxylic acid and 100% CHDM, to provide a polyester known as PCCD). The foregoing are all polyesters within the definition. All of these polyesters have free carboxyl and/or alcohol groups, usually as end groups that can react with an epoxy silane or other carboxy-reactive material.

In one embodiment, the polyester is polybutylene terephthalate, polyethylene terephthalate, a combination of polyethylene naphthalate and polybutylene naphthalate, polytrimethylene terephthalate, polycyclohexane dimethanol terephthalate, polycyclohexane dimethanol terephthalate copolymers with ethylene glycol, or a combination comprising at least one of the foregoing polyesters. Polybutylene terephthalate in particular can be used.

The carboxy-reactive material is a monofunctional or a polyfunctional carboxy-reactive material that can be either polymeric or non-polymeric. Examples of carboxy-reactive groups include epoxides, carbodiimides, orthoesters, oxazolines, oxiranes, aziridines, and anhydrides. The carboxy-reactive material can also include other functionalities that are either reactive or non-reactive under the described processing conditions. Non-limiting examples of reactive moieties include reactive silicon-containing materials, for example epoxy-modified silicone and silane monomers and polymers. If desired, a catalyst or co-catalyst system can be used to accelerate the reaction between the carboxy-reactive material and the polyester.

The term “polyfunctional” or “multifunctional” in connection with the carboxy-reactive material means that at least two carboxy-reactive groups are present in each molecule of the material. Particularly useful polyfunctional carboxy-reactive materials include materials with at least two reactive epoxy groups. The polyfunctional epoxy material can contain aromatic and/or aliphatic residues. Examples include epoxy novolac resins, epoxidized vegetable (e.g., soybean, linseed) oils, tetraphenylethylene epoxide, styrene-acrylic copolymers containing pendant glycidyl groups, glycidyl methacrylate-containing polymers and copolymers, and difunctional epoxy compounds such as 3,4-epoxycyclohexylmethyl-3,4-epoxycyclohexanecarboxylate.

In one embodiment, the polyfunctional carboxy-reactive material is an epoxy-functional polymer, which as used herein include oligomers. Exemplary polymers having multiple epoxy groups include the reaction products of one or more ethylenically unsaturated compounds (e.g., styrene, ethylene and the like) with an epoxy-containing ethylenically unsaturated monomer (e.g., a glycidyl C₁₋₄ (alkyl)acrylate, allyl glycidyl ethacrylate, and glycidyl itoconate).

For example, in one embodiment the polyfunctional carboxy-reactive material is a styrene-acrylic copolymer (including an oligomer) containing glycidyl groups incorporated as side chains. Several useful examples are described in the International Patent Application WO 03/066704 A1, assigned to Johnson Polymer, LLC, which is incorporated herein by reference in its entirety. These materials are based on copolymers with styrene and acrylate building blocks that have glycidyl groups incorporated as side chains. A high number of epoxy groups per polymer chain is desired, at least about 10, for example, or greater than about 15, or greater than about 20. These polymeric materials generally have a molecular weight greater than about 3000, preferably greater than about 4000, and more preferably greater than about 6000. These are commercially available from Johnson Polymer, LLC under the Joncryl® trade name, preferably the Joncryl® ADR 4368 material.

Another example of a carboxy-reactive copolymer is the reaction product of an epoxy-functional C₁₋₄(alkyl)acrylic monomer with a non-functional styrenic and/or C₁₋₄(alkyl)acrylate and/or olefin monomer. In one embodiment the epoxy polymer is the reaction product of an epoxy-functional (meth)acrylic monomer and a non-functional styrenic and/or (meth)acrylate monomer. These carboxy reactive materials are characterized by relatively low molecular weights. In another embodiment, the carboxy reactive material is an epoxy-functional styrene (meth)acrylic copolymer produced from an epoxy functional (meth)acrylic monomer and styrene. As used herein, the term “(meth)acrylic” includes both acrylic and methacrylic monomers, and the term “(meth)acrylate” includes both acrylate and methacrylate monomers. Examples of specific epoxy-functional (meth)acrylic monomers include, but are not limited to, those containing 1,2-epoxy groups such as glycidyl acrylate and glycidyl methacrylate.

Suitable C₁₋₄(alkyl)acrylate comonomers include, but are not limited to, acrylate and methacrylate monomers such as methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, and isobornyl methacrylate. Combinations comprising at least one of the foregoing comonomers can be used.

Suitable styrenic monomers include, but are not limited to, styrene, alpha-methyl styrene, vinyl toluene, p-methyl styrene, t-butyl styrene, o-chlorostyrene, and mixtures comprising at least one of the foregoing. In certain embodiments the styrenic monomer is styrene and/or alpha-methyl styrene.

In another embodiment, the carboxy reactive material is an epoxy compound having two terminal epoxy functionalities, and optionally additional epoxy (or other) functionalities. The compound can further contain only carbon, hydrogen, and oxygen. Difunctional epoxy compounds, in particular those containing only carbon, hydrogen, and oxygen can have a molecular weight of below about 1000 g/mol, to facilitate blending with the polyester resin. In one embodiment the difunctional epoxy compounds have at least one of the epoxide groups on a cyclohexane ring. Exemplary difunctional epoxy compounds include, but are not limited to, 3,4-epoxycyclohexyl-3,4-epoxycyclohexyl carboxylate, bis(3,4-epoxycyclohexylmethyl)adipate, vinylcyclohexene di-epoxide, bisphenol diglycidyl ethers such as bisphenol-A diglycidyl ether, tetrabromobisphenol-A diglycidyl ether, glycidol, diglycidyl adducts of amines and amides, diglycidyl adducts of carboxylic acids such as the diglycidyl ester of phthalic acid the diglycidyl ester of hexahydrophthalic acid, and bis(3,4-epoxy-6-methylcyclohexylmethyl)adipate, butadiene diepoxide, vinylcyclohexene diepoxide, dicyclopentadiene diepoxide, and the like. Especially preferred is 3,4-epoxycyclohexyl-3,4 epoxycyclohexylcarboxylate.

The difunctional epoxide compounds can be made by techniques well known to those skilled in the art. For example, the corresponding α- or β-dihydroxy compounds can be dehydrated to produce the epoxide groups, or the corresponding unsaturated compounds can be epoxidized by treatment with a peracid, such as peracetic acid, in well-known techniques. The compounds are also commercially available.

Other preferred materials with multiple epoxy groups are acrylic and/or polyolefin copolymers and oligomers containing glycidyl groups incorporated as side chains. Suitable epoxy-functional materials are available from Dow Chemical Company under the tradename DER332, DER661, and DER667; from Resolution Performance Products (now Hexion Performance Chemicals, Inc.) under the trade name EPON Resin 1001F, 1004F, 1005F, 1007F, and 1009F; from Shell Oil Corporation (now Hexion Performance Chemicals, Inc.) under the tradenames EPON 826, 828, and 871; from Ciba-Giegy Corporation under the tradenames CY-182 and CY-183; and from Dow Chemical Co. under the tradename ERL-4221 and ERL-4299. As set forth in the Examples, Johnson Polymer Co. (now owned by BASF) is a supplier of an epoxy functionalized material known as ADR4368 and ADR4300. A further example of a polyfunctional carboxy-reactive material is a copolymer or terpolymer including units of ethylene and glycidyl methacrylate (GMA), sold by Arkema under the trade name LOTADER®, i.e., a In one embodiment, the carboxy-reactive material is a combination comprising a poly(ethylene-glycidyl methacrylate-co-methacrylate).

In still another embodiment, the carboxy-reactive material is a multifunctional material having two or more reactive groups, wherein at least one of the groups is an epoxy group and at least one of the groups is a group reactive with the polyester, but is not an epoxy group. The second reactive group can be a hydroxyl, an isocyanate, a silane, and the like.

Examples of such multifunctional carboxy-reactive materials include materials with a combination of epoxy and silane functional groups, preferably terminal epoxy and silane groups. The epoxy silane is generally any kind of epoxy silane wherein the epoxy is at one end of the molecule and attached to a cycloaliphatic group and the silane is at the other end of the molecule. A desired epoxy silane within that general description is of the following formula:

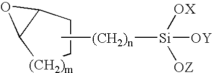

wherein m is an integer of 1, 2 or 3, n is an integer of 1 to 6, inclusive, and X, Y, and Z are the same or different, preferably the same, and are alkyl groups of one to twenty carbon atoms, inclusive, cycloalkyl of four to ten carbon atoms, inclusive, alkylene phenyl wherein alkylene is one to ten carbon atoms, inclusive, and phenylene alkyl wherein alkyl is one to six carbon atoms, inclusive. Desirable epoxy silanes within this range are compounds wherein m is 2, n is 1 or 2, desirably 2, and X, Y, and Z are the same and are alkyl of 1, 2, or 3 carbon atoms inclusive. Epoxy silanes within the range which in particular can be used are those wherein m is 2, n is 2, and X, Y, and Z are the same and are methyl or ethyl.

Such materials include, for example, β-(3,4-epoxycyclohexyl)ethyltriethoxysilane, available under the trade name CoatOSil 1770 from GE. Other examples are β-(3,4-epoxycyclohexyl)ethyltrimethoxysilane, available under the trade name Silquest A-186 from GE, and 3-glycidoxypropyltriethoxysilane, available under the trade name Silquest Y-15589 from GE. In one embodiment, the carboxy-reactive material is a combination comprising a poly(ethylene-glycidyl methacrylate-co-methacrylate) and a dicycloaliphatic diepoxy compound.

The carboxy-reactive material is added to the polyester compositions in amounts effective to improve visual and/or measured physical properties. In one embodiment, the carboxy-reactive materials are added to the polyester compositions in an amount effective to improve the solvent resistance of the composition, in particular the fuel-resistance of the composition. A person skilled in the art may determine the optimum type and amount of any given carboxy-reactive material without undue experimentation, using the guidelines provided herein.

The type and amount of the carboxy reactive material will depend on the desired characteristics of the composition, the type of polyester used, the type and amount of other additives present in the composition and like considerations, and is generally at least 0.01 weight percent (wt. %) based on the weight of the total composition. In one embodiment, the amount of the carboxy-reactive material is 0.01 to 30 wt. %, in some embodiments 0.01 to 20 wt. %. Alternatively, the carboxy-reactive compound comprises an epoxy group, and the amount of epoxy in the polyester composition is 5 to 320 milliequivalent epoxy group per 1.0 kg of the polyester.

In one embodiment, a catalyst can optionally be used to catalyze the reaction between the carboxy-reactive material and the polyester. If present, the catalyst can be a hydroxide, hydride, amide, carbonate, borate, phosphate, C₂₋₃₆ carboxylate, C₂₋₁ enolate, or a C₂₋₃₆ dicarboxylate of an alkali metal such as sodium, potassium, lithium, or cesium, of an alkaline earth metal such as calcium, magnesium, or barium or other metal such as zinc or a lanthanum metal; a Lewis catalyst such as a tin or titanium compound; a nitrogen-containing compound such as a quaternary ammonium halide (e.g., dodecyltrimethylammonium bromide), or other ammonium salt, including a C₁₋₃₆ tetraalkyl ammonium hydroxide or acetate; a C₁₋₃₆ tetraalkyl phosphonium hydroxide or acetate; or an alkali or alkaline earth metal salt of a negatively charged polymer. Mixtures comprising at least one of the foregoing catalysts can be used, for example a combination of a Lewis acid catalyst and one of the other foregoing catalysts.

Specific exemplary catalysts include but are not limited to alkaline earth metal oxides such as magnesium oxide, calcium oxide, barium oxide, and zinc oxide, tetrabutyl phosphonium acetate, sodium carbonate, sodium bicarbonate, sodium tetraphenyl borate, dibutyl tin oxide, antimony trioxide, sodium acetate, calcium acetate, zinc acetate, magnesium acetate, manganese acetate, lanthanum acetate, sodium benzoate, sodium stearate, sodium benzoate, sodium caproate, potassium oleate, zinc stearate, calcium stearate, magnesium stearate, lanthanum acetylacetonate, sodium polystyrenesulfonate, the alkali or alkaline earth metal salt of a PBT-ionomer, titanium isopropoxide, and tetraammonium hydrogensulfate. Mixtures comprising at least one of the foregoing catalysts can be used.

In another specific embodiment, the catalyst can be a boron-containing compound such as boron oxide, boric acid, a borate salt, or a combination comprising at least one of the foregoing boron-containing compounds. More particularly, boric acid and/or a borate salt is used, even more particularly a borate salt. As used herein, a “borate salt” (or simply “borate” ) means the salt of a boric acid. There are different boric acids, including metaboric acid (HBO₂), orthoboric acid (H₃BO₃), tetraboric acid (H₂B₄O₇), and pentaboric acid. Each of these acids can be converted to a salt by reaction with a base. Different bases can be used to make different borates. These include amino compounds, which give ammonium borates, and hydrated metal oxides such as sodium hydroxide, which gives sodium borates. These borates can be hydrated or anhydrous. For example, sodium tetraborate is available in the anhydrous form, and also as the pentahydrate and the decahydrate. Suitable borate salts are alkali metal borates, with sodium, lithium, and potassium being preferred, and with sodium tetraborate being especially suitable. Other suitable metal borates are divalent metal borates, with alkaline earth metal borates being preferred, in particular calcium and magnesium. Trivalent metal borates, such as aluminum borate, can also be used.

In another embodiment, the catalyst is a salt containing an alkali metal compound, for example an alkali metal halide, an alkali metal C₂₋₃₆ carboxylate, an alkali metal C₂₋₁₈ enolate, an alkali metal carbonate, an alkali metal phosphate, and the like. Illustrative compounds within this class are lithium fluoride, lithium iodide, potassium bromide, potassium iodide, sodium dihydrogen phosphate, sodium acetate, sodium benzoate, sodium caproate, sodium stearate, and sodium ascorbate.

In still another embodiment, a metal salt of an aliphatic carboxylic acid containing at least 18 carbon atoms, particularly an alkali metal stearate such as sodium stearate has certain advantages. For example use of one of these catalysts allows extrusion of the polyester compositions at substantially higher feed rates than the rates usable in the absence of such catalysts. These catalysts also tend to suppress the formation of acrolein, a by-product from glycidyl reagents. The catalysts can also impart substantially less odor to the composition than certain other compounds useful as catalysts, especially amines.

The type and amount of the catalyst will depend on the desired characteristics of the composition, the type of polyester used, the type and amount of the carboxy-reactive material, the type and amount of other additives present in the composition, and like considerations, and is generally at least 1 ppm based on the weight of the total composition. In one embodiment, the amount of the catalyst is 1 ppm to 0.10 wt. %.

The polyester modified with the epoxy silane can be blended with any of the usual additives and property modifiers that polyesters are usually mixed with, with the proviso that the additives are selected so as to not significantly adversely affect the desired properties of the composition, for example, solvent resistance. Exemplary additives include, for example, flame retardants, antioxidants, heat stabilizers, light stabilizers, plasticizers, lubricants, antistatic agents, colorants, mold release agents, and/or fillers such as glass, clay, mica, and the like. Polymer blends can be made with reacted polyester or can be made with the unreacted polyester, and the polyester can then be reacted with the carboxy-reactive compound, e.g., an epoxy silane or diepoxy compound. Examples of polymers that can be blended to make polymer blends are aromatic polycarbonates, polysulfones, polyethersulfones, and impact modifiers.

The thermoplastic composition can further include impact modifier(s). Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

A specific type of impact modifier is an elastomer-modified graft copolymer comprising (i) an elastomeric (i.e., rubbery) polymer substrate having a Tg less than about 10° C., more specifically less than about −10° C., or more specifically about −40° to −80° C., and (ii) a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than about 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers. Materials suitable for use as the rigid phase include, for example, monovinyl aromatic monomers such as styrene and alpha-methyl styrene, and monovinylic monomers such as acrylonitrile, acrylic acid, methacrylic acid , and the C₁-C₆ esters of acrylic acid and methacrylic acid, specifically methyl methacrylate.

Suitable impact modifiers include, for example, a natural rubber, a low-density polyethylene, a high-density polyethylene, a polypropylene, a polystyrene, a polybutadiene, a styrene-butadiene copolymer, an ethylene-propylene copolymer, an ethylene-methyl acrylate copolymer, an ethylene-ethyl acrylate copolymer, an ethylene-vinyl acetate copolymer, a polyethylene terephthalate-poly(tetramethyleneoxide)glycol block copolymer, a polyethylene terephthalate/isophthalate-poly(tetramethyleneoxide)glycol block copolymer, or a combination comprising at least one of the foregoing impact modifiers. Other specific exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN).

The type and amount of the impact modifier will depend on the desired characteristics of the composition, the type of polyester used, the type and amount of the carboxy-reactive material, the type and amount of other additives present in the composition, and like considerations, and is readily determined by one of ordinary skill in the art without undue experimentation. The impact modifier is generally present in an amount of 2 to 30 wt % of the total weight of the composition comprising the reaction product.

The polyester can be mixed with additives, other polymers, and/or impact modifiers or other blend components and then reacted with the carboxy-reactive material, e.g., an epoxy silane or a diepoxy compound. Alternatively, the polyester can be reacted with the carboxy-reactive material and then blended with additives, other polymers, and/or impact modifiers. The carboxy-reactive material is theoretically combinable with other components of the blend, and then mixed with the polyester.

In one embodiment, the carboxy-reactive material, e.g., the epoxy silane, is reacted with the polyester by simply bringing the two components together at a temperature and time period sufficient to effect the desired reaction. For example, PBT 195, Intrinsic Viscosity (IV) 0.66 from GE together with PBT 315, IV 1.2 from GE, are combined with various additives such as potassium diphenylsulfone sulfonate (KSS), a flame retardant, a hindered phenol such as Irganox 1010 from Ciba Geigy, a catalyst such as sodium stearate, a mold release such as pentaerythritol tetrastearate (PETS) and the epoxy silane beta-(3,4-epoxycyclohexyl)ethyl triethoxysilane (CoatOSil 1770) from GE in an extruder where they are tumble blended and then extruded in a 27 mm twin screw with a vacuum vented mixing screw at a barrel and die head temperature between 240 and 265° C. and 450 rpm screw speed. The extrudate is cooled through a water bath prior to pelletizing.

When an epoxy silane is used, the quantity of epoxy silane employed as a percentage of polyester present in the composition is generally 0.01 to 20 wt. %, more specifically 0.2 to 2.0 wt %, and within that range a minimum of about 0.5 wt %. Generally, further increases in desirable properties are not observable beyond a maximum of about 1.75 wt %.

Various processes can be used to bring about a desired final product. Injection molding, blow molding, thermoforming, casting or coating to form films, pultrusion, slot film extrusion, blown bubble film extrusion, meltblowing of non-woven webs, spunbonding of non-woven webs, and the like are processes that can be employed. Where solvent resistance is particularly desirable, for example in products and parts exposed to gasoline, vehicular parts like gas caps, fenders, gasoline tanks, and the like can be successfully prepared using the above processes. Any other desired article can also be prepared using certain of the processes.

In one embodiment, the composition provides resistance to liquid fuel, and is therefore of particular utility in parts that contact liquid fuel, in particular containers for liquid fuel. The compositions can also be used to form fibers, e.g., fibers having a diameter of 0.1 to 100 micrometers. The fibers can be provided in the form a woven or nonwoven mat (fibrous web). In one embodiment, fibrous webs or other articles are produced directly from the reacted polyester composition using a high-velocity air (or other attenuating force), in a melt blowing process or spunbonding process that forms a nonwoven mat. Such fibers can have a diameter from 0.1 to 100 micrometers, more typically 1 to 50 micrometers, still more typically 2 to 5, or 2 to 4 micrometers.

“Liquid fuel” as used herein includes fuels such as gasoline or diesel fuel. Also included are fuels that contain up to 20, up to 40, up to 60, up to 80, up to 90, or even up to 99.9 volume percent of a C₁₋₆ alcohol, in particular ethanol and/or methanol. A mixture of ethanol and methanol can also be used. In one embodiment, the liquid fuel includes a gasoline fuel or a diesel fuel that contains up to 20, up to 40, up to 60, up to 80, up to 90, or up to 99.9 volume percent of percent of a C₁₋₆ alcohol, in particular ethanol and/or methanol. In a more specific embodiment, a liquid fuel comprises 10 to 90 volume % of regular gasoline and 10 to 90 volume % of a C₁-C₆ alcohol. The term “regular gasoline” fuel or “regular diesel” fuel as used herein refers to a fuel that is formulated without ethanol or other alcohol. As fuel systems now contain various levels of alcohol, additional solvent resistance to alcohol improves part performance and service life. In another embodiment, the liquid fuel comprises an alcohol, in particular a C₁-C₆ alcohol, or mixtures of such alcohols, but no gasoline or diesel fuel. Other additives known for use in liquid fuels can be present in any of the foregoing embodiments.

Resistance to a liquid fuel is most conveniently determined by measuring the molecular weight of a sample of the polyester and carboxy-reactive component composition (which will include both reacted and unreacted polyester) before and after exposure to the liquid fuel or a mixture of solvents representative of a liquid fuel. In one embodiment, the reacted polyester composition, or an article molded or extruded from the composition, retains at least 75%, specifically at 80%, more specifically least 90%, of its initial molecular weight after immersion in a liquid fuel at 70° C. for 14 days. Alternatively the reacted polyester composition, or an article molded or extruded from the composition, retains at least 75%, specifically at least 85%, more specifically at least 90%, and even more specifically at least 95% of its initial molecular weight after immersion in a liquid fuel at 70° C. for 7 days. Alternatively, the reacted polyester composition, or an article molded or extruded from the composition, retains at least 85%, specifically at least 95% of its initial molecular weight after immersion in a liquid fuel at 70° C. for 21 days.

In another embodiment, the reacted polyester composition in the form of at least one fiber, e.g., fibers having a diameter of 1 to 50, specifically 1 to 20 micrometers, more specifically 5 to 11 micrometers, retains at least 80%, specifically at least 90%, of its initial molecular weight after immersion in a mixture of 85 volume % ethanol and 15 volume % regular gasoline for 7 days at 70° C. Alternatively, the reacted polyester composition in the form of fibers having a diameter of 1 to 50, specifically 1 to 20 micrometers, more specifically 5 to 11 micrometers retains at least 70%, specifically at least 80%, more specifically at least 90% of its initial molecular weight after immersion in a mixture of 85 volume % ethanol and 15 volume % regular gasoline for 14 days at 70° C.

The reacted polyester composition in the form of fibers having a diameter of 1 to 50, specifically 1 to 20, more specifically 5 to 11 micrometers, can alternatively retain at least 70%, specifically at least 80%, more specifically at least 90% of its initial molecular weight after immersion in a mixture of 85 volume % ethanol and 15 volume % regular gasoline for 21 days at 70° C. In another advantageous embodiment, the reacted polyester composition in the form of fibers having a diameter of 1 to 50, specifically 1 to 20, more specifically 5 to 11 micrometers retains at least 70%, specifically at least 80%, more specifically at least 90% of its initial molecular weight after immersion in a mixture of 85 volume % ethanol and 15 volume % regular gasoline for 14 days at 70° C.

In another embodiment, the reacted polyester composition, in the form of an injection-molded article, e.g., ASTM Type I tensile bar, retains at least 70%, specifically at least 80%, more specifically at least 90%, even more specifically at least 95% of its initial molecular weight after immersion in a mixture of 45 volume % toluene, 45 volume % isooctane, and 10 volume % ethanol for 7 days at 70° C. Alternatively, the reacted polyester composition, in the form of an injection-molded article such as an injection-molded ASTM Type I tensile bar, retains at least 70%, specifically at least 80%, more specifically at least 90% of its initial molecular weight after immersion in a mixture of 45 volume % toluene, 45 volume % isooctane, and 10 volume % ethanol for 14 days at 70° C.

In still other embodiments, the composition further comprises an impact modifier. In one embodiment, the reacted polyester composition (in the impact-modified composition in the form of an injection-molded article, such as an injection-molded ASTM Type I tensile bar), retains at least 80%, specifically at least 90%, even more specifically at least 95% of its initial molecular weight after immersion in a mixture of 45 volume % toluene, 45 volume % isooctane, and 10 volume % ethanol for 7 days at 70° C. Alternatively, the reacted polyester composition (in the impact-modified composition in the form of an injection-molded article such as an ASTM Type I tensile bar), retains at least 85%, specifically at least 90%, even more specifically at least 95% of its initial molecular weight after immersion in a mixture of 45 volume % toluene, 45 volume % isooctane, and 10 volume % ethanol for 14 days at 70° C. The reacted polyester composition (in the impact-modified composition in the form of an injection-molded article, e.g., an ASTM Type I tensile bar, can also retain at least 80%, specifically at least 85%, more specifically at least 90%, and even more specifically at least 95% of its initial molecular weight after immersion in a mixture of 45 volume % toluene, 45 volume % isooctane, and 10 volume % ethanol for 21 days at 70° C.

As such, the invention provides previously unavailable advantages. The compositions described herein can be molded or extruded into articles having excellent resistance to liquid fuels, in particular liquid fuels containing alcohols. Accordingly, it is now possible to make articles that are resistant to such environments. Such articles will have better performance over time, and a longer useful lifetime. In addition, the compositions can also retain the other advantageous properties of polyesters, for example impact resistance.

The invention is further described in the following illustrative examples in which all parts and percentages are by weight unless otherwise indicated. The examples show extruded articles and fibers exhibiting increased resistance to organic solvent(s) over time using molecular weight as a test system.

### EXAMPLES

Materials:

Table 1 summarizes the material used in the experiments.

TABLE 1
Materials

| Abbreviation | Description |
|---|---|
| PBT 195 | Poly(1,4-butylene terephthalate) from General Electric Company, |
| | intrinsic viscosity (IV) of 0.66 cm³/g as measured in a 60:40 |
| | phenol/tetrachloroethane mixture. |
| PBT 315 | Poly(1,4-butylene terephthalate) from General Electric Company, |
| | intrinsic viscosity (IV) of 1.2 cm³/g as measured in a 60:40 |
| | phenol/tetrachloroethane mixture. |
| PET IV 0.8 | Poly(1,4-ethylene terephthalate), intrinsic viscosity (IV) of 0.8 |
| | cm³/g as measured in a 60:40 phenol/tetrachloroethane mixture |
| CoatOSil 1770 | Beta-(3,4-epoxycyclohexyl)ethyl triethoxysilane from GE |
| | Silicones |
| | 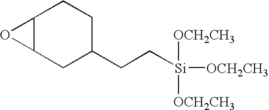 |
| ERL-4221 | 3,4-epoxycyclohexylmethyl-3,4-epoxycyclohexyl carboxylate, |
| | from DOW Chemical Co. |
| ADR-4368 | Copolymer of styrene and glycidyl methacrylate, Mw about 6800, |
| | epoxy equivalent weight about 285 eq./mol, Johnson Polymer Co. |
| LOTADER | Random Terpolymer of Ethylene (E), Acrylic Ester (AE) and |
| | Glycidyl Methacrylate Ester (GMA), sold as LOTADER AX8900 |
| | by Arkema |
| MBS | Methacrylate-butadiene-styrene emulsion copolymer having a |
| | core-shell structure, sold as EXL-2691 by Rohm & Haas |
| ABS | Acrylonitrile-butadiene-styrene emulsion copolymer having a core- |
| | shell structure from General Electric Co. |
| KSS | Potassium diphenylsulfone sulfonate (KSS) |
| Irganox 1010 | Pentaerythritol tetrakis(3,5-di-tert-butyl-4- |
| | hydroxyhydrocinnamate), a hindered phenol sold as IRGANOX |
| | 1010 by Ciba Geigy |
| Irganox 1076 | Octadecyl 3-(3,5-di-tert-butyl-4-hydroxyphenyl)propionate, |
| | Hindered phenol heat stabilizer, IRGANOX 1076 by Ciba Geigy |
| TSAN | 50/50 wt % polytetrafluoroethylene blended with poly(styrene-co- |
| | acrylonitrile) from General Electric Co. |
| Seenox 412S | Thioester, Pentaerythritol tetrakis(3-(dodecylthio)propionate) sold |
| | as SEENOX 412-S from Crompton |
| Irgaphos 168 | Phosphite, 2,4-di-tert-butylphenol phosphite (3:1) sold as |
| | IRGAPHOS 168 by Ciba Geigy |
| NaSt | Sodium stearate, catalyst |
| PETS | Pentaerythritol tetrastearate, mold release agent |

Extrusion and Molding Conditions:

For the Examples shown in Tables 1-5, the ingredients were tumble blended and then extruded on 27 mm twin screw extruder with a vacuum vented mixing screw, at a barrel and die head temperature between 240 and 265° C. and 450 ppm screw speed. The extrudate was cooled through a water bath prior to pelletizing. Test parts were injection molded on a van Dorn molding machine with a set temperature of approximately 250° C. The pellets were typically dried for 3-4 hours at 120° C. in a forced air-circulating oven prior to injection molding.

For the Examples shown in Table 7, the ingredients were tumble blended and then extruded on 27 mm twin screw extruder with a vacuum vented mixing screw, at a barrel and die head temperature between 240 and 265° C. and a 300 rpm screw speed. The extrudate was cooled through a water bath prior to pelletizing. Molded articles, ASTM Type I tensile bars, were injection molded on a van Dorn molding machine with a set temperature of approximately 240-265° C. The pellets were dried for 3-4 hours at 120° C. in a forced air-circulating oven prior to injection molding.

For the Examples shown in Table 6, the ingredients were tumble blended and then extruded on 27 mm twin screw extruder with a vacuum vented mixing screw, at a barrel and die head temperature between 240 and 270° C. The extrudate was cooled through a water bath prior to pelletizing. Extruded articles, in particular fibers, were made by a melt blowing process. Polymer pellets were fed to an extruder at a temperature of 240-270° C. The polymer melt was extruded through 121 holes with 0.45 mm diameter. The extruded strand was then formed into fibers under high-velocity air.

Testing:

Tensile properties were tested on molded articles, in particular Type I tensile bars, at room temperature with a crosshead speed of 2 in./min. according to ASTM D648.

Fuel resistance was tested by immersing tensile bars or fibers in gasoline (alcohol-free, i.e., “regular gasoline” from BP) or the following mixtures, each ratio being based on volume:
Fuel CE10: toluene/isooctane/ethanol at a ratio of 45%/45%/10%;
Fuel CE15: toluene/isooctane/ethanol, at a ratio of 42.5%/42.5%/15%;
E85/gasoline: ethanol/“regular” gasoline from BP at a ratio of 85%/15%; and
Fuel CM15: toluene/isooctane/methanol at a ratio of 42.5%/42.5%/15%.

Molecular weight was determined by gel permeation chromatography (GPC). A Waters 2695 separation module equipped with a single PL HFIP gel (250×4.6 mm) and a Waters 2487 Dual Wavelength Absorbance Detector (signals observed at 273 nm) were used for GPC analysis. Typically, samples were prepared by dissolving 50 mg of the polymer pellets in 50 mL of 5/95 volume % hexafluoroisopropyl alcohol/chloroform solution. The results were processed using a Millennium 32 Chromatography Manager V 4.0 Reported molecular weights are relative to polystyrene standards. As used herein, “molecular weight” refers to weight average molecular weight (Mw).

Results and Discussion:

TABLE 2
Gasoline Resistance at room temperature.

| Formulation | | C1 | C2 | C3 | C4 | C5 | E1 | E2 | E3 |
|---|---|---|---|---|---|---|---|---|---|
| PBT 315 | % | | 100 | 49.95 | 49.9 | 49.65 | 48.95 | 48.9 | 48.65 |
| PBT 195 | % | 100 | | 50 | 50 | 50 | 50 | 50 | 50 |
| Irganox 1010 | % | | | 0.05 | 0.05 | 0.05 | 0.05 | 0.05 | 0.05 |
| CoatOSil 1770 | % | | | 0 | 0 | 0 | 1 | 1 | 1 |
| Na Stearate | % | | | 0 | 0.05 | 0 | 0 | 0.05 | 0 |
| KSS | % | | | 0 | 0 | 0.3 | 0 | 0 | 0.3 |
| Physical Properties | | | | | | | | | |
| MVR-pellets* | cc/10 min. | 100 | 10 | 38 | 40 | 39 | 10 | 0 | 13 |
| MV at 250° C. and | Pa-s | 67 | 1047 | 301 | — | — | 933 | 4721 | 732 |
| 24/s** | | | | | | | | | |
| MV at 250° C. and | Pa-s | 65 | 344 | 159 | — | — | 238 | 527 | 204 |
| 1520/s | | | | | | | | | |
| MV at 250° C. and | Pa-s | — | 213 | 115 | — | — | 152 | 337 | 138 |
| 3454/s | | | | | | | | | |
| Tensile Stress @yield | Mpa | 61 | 59 | 59 | 60 | 60 | 58 | 65 | 58 |
| Tensile Stress @break | Mpa | 59 | 30 | 39 | 45 | 48 | 27 | 49 | 33 |
| Tensile Elongation at | % | 15 | 280 | 32 | 29 | 44 | 202 | 30 | 84 |
| break | | | | | | | | | |
| GPC-Mn | kg/mol | 18 | 42 | 27.7 | 27.7 | 28.5 | 28.8 | 30 | 29.2 |
| GPC-Mw | kg/mol | 45 | 105 | 85.4 | 84.2 | 85.7 | 88.9 | 97.3 | 89.3 |
| Mw/Mn | | 2.5 | 2.5 | 3.1 | 3 | 3.1 | 3.1 | 3.2 | 3.1 |
| Gasoline Resistance⁺ | | | | | | | | | |
| TS⁺⁺ Retention after 1 | % | 83% | 87% | 98% | 96% | 91% | 99% | 99% | 97% |
| day | | | | | | | | | |
| TS Retention after 2 day | % | 78% | 86% | 91% | 90% | 87% | 99% | 98% | 96% |
| TS Retention after 4 day | % | 81% | 92% | 93% | 91% | 92% | 99% | 99% | 98% |
| TS Retention after 8 day | % | 77% | 82% | 89% | 88% | 87% | 96% | 99% | 98% |

*MVR (melt volume rate) was measured at 250° C. with a load of 2.16 kg after 4 minutes dwell time
**MV (Melt Viscosity) was measured by capillary viscometer at various shear rate
⁺ASTM Tensile Type I bars were immersed in regular gasoline from BP co. with 2.5% strain.
⁺⁺Tensile Stress at Yield

Table 2 shows the effect of the epoxy silane on physical properties and chemical resistance to gasoline. Formulations of C3-C5 & E1-E3 were designed to investigate the effect of epoxy silane and additives on PBT. Tensile bars were tested under 2.5% strain in gasoline at room temperature. Examples of E1-E3 with epoxy silane show substantially higher retention in tensile strength after gasoline exposure than comparative examples C1-C5.

TABLE 3
The interaction between PBT type and epoxy silane.

| Formulation | | C6 | E4 | C7 | E5 |
|---|---|---|---|---|---|
| PBT315 | % | 100.0 | 98.5 | | |
| PBT195 | % | | | 100.0 | 98.5 |
| CoatOSil 1770 | % | | 1.5 | | 1.5 |
| NaSt | % | | 0.01 | | 0.01 |
| KSS | % | | | | |
| Gasoline Resistance* | | | | | |
| TS Retention after 4 day** | % | 92% | 98% | 81% | 87% |

*ASTM Tensile Type I bars were immersed in regular gasoline from BP co. with 2.5% strain.
**Tensile Stress at Yield

Table 3 shows that the epoxy silane improves gasoline resistance of PBT195 and PBT315.

TABLE 4
Gasoline resistance at 82° C.

| Formulation | | C8 | C9 | E6 | E7 | E8 |
|---|---|---|---|---|---|---|
| PBT 315 | % | | 100 | 48.7 | 48.7 | 48.4 |
| PBT 195 | % | 100 | | 50 | 50 | 50 |
| Irganox 1010 | % | | | 0.05 | 0.05 | 0.05 |
| CoatOSil 1770 | % | | | 1 | 1 | 1 |
| Na Stearate | % | | | 0 | 0.05 | 0 |
| KSS | % | | | 0 | 0 | 0.3 |
| Carbon Black | % | | | 0.25 | 0.25 | 0.25 |
| Gasoline Resistance | | | | | | |
| TS before exposure* | Mpa | 55 | 54 | 59 | 59 | 59 |
| TS Retention after 7 days, | % | 83% | 87% | 94% | 96% | 94% |
| Tensile bars under no strain | | | | | | |
| TS Retention after 7 days, | % | 80% | 85% | 94% | 91% | 94% |
| Tensile bars under 1.0% strain | | | | | | |

*Tensile Stress at Yield

Table 4 shows the effect of the epoxy silane on physical properties and chemical resistance to gasoline at elevated temperature. Tensile bars were tested under 0% or 1.0% strain in gasoline at 82° C. Examples of E6-E8 with epoxy silane show substantially higher retention in tensile strength after gasoline exposure at 82° C. than comparative examples C8-C9.

TABLE 5
Chemical resistance to Fuel CM15 at room temperature.

| Formulation | | C10 | C11 | E9 | E10 | E11 |
|---|---|---|---|---|---|---|
| PBT 315 | % | | 100 | 48.7 | 48.7 | 48.4 |
| PBT 195 | % | 100 | | 50 | 50 | 50 |
| Irganox 1010 | % | | | 0.05 | 0.05 | 0.05 |
| CoatOSil 1770 | % | | | 1 | 1 | 1 |
| Na Stearate | % | | | 0 | 0.05 | 0 |
| KSS | % | | | 0 | 0 | 0.3 |
| Carbon Black | % | | | 0.25 | 0.25 | 0.25 |
| Resistance to Fuel CM15* | | | | | | |
| TS before exposure*** | Mpa | 60 | 60 | 58 | 57 | 59 |
| TS Retention after 4 days, | % | 86% | 87% | 95% | 98% | 95% |
| Tensile bars under 2.5% strain | | | | | | |
| TS Retention after 8 days, | % | 14% | 85% | 94% | 96% | 95% |
| Tensile bars under 2.5% strain | | | | | | |

*Fuel: mixture of 15% Methanol, 42.5% Toluene, 42.5% Isooctane
**ASTM Tensile Type I bars were immersed at room temperature
***Tensile Stress at Yield

Table 5 shows the effect of the epoxy silane on physical properties and chemical resistance to Fuel C. Tensile bars were tested under 2.5% strain in Fuel C at room temperature. Examples of E9-E11 with epoxy silane show substantially higher resistance to Fuel C than comparative examples C10-C11.

To generate the data in Table 6, melt-blown fibers were immersed in E85/gasoline at 70° C. in a flask under reflux. The molecular weight of the PBT in the fibers was measured before and after fiber samples were exposed to fuel.

TABLE 6
Fuel Resistance of polyester fibers to E85/gasoline.

| Formulation | Unit | C12 | C13 | C14 | E12 | E13 | E14 |
|---|---|---|---|---|---|---|---|
| PBT 315 | % | 100 | — | — | 44.5 | 75 | 75 |
| PBT 195 | % | — | 100 | — | 44.5 | 25 | 25 |
| PET IV 0.8 | % | — | — | 100 | — | — | — |
| CoatOSil 1770 | % | — | — | — | 1.0 | — | — |
| ERL 4221 | % | — | — | — | — | 1.1 | 1.1 |
| NaSt | % | — | — | — | — | 0.07 | 0.07 |
| Fuel Resistance | | — | — | — | — | — | — |
| Fiber Diameter | micrometer | 7.4 | 8.8 | 5.4 | 7.2 | 11 | 5 |
| Initial Mw | kg/mol | 86.9 | 55.6 | 49.2 | 69.9 | 70.0 | 71.9 |
| Mw retention after 7 days at 70° C. | % | 49% | 20% | 69% | 84% | 92% | 94% |
| Mw retention after 14 day at 70° C. | % | 31% | 33% | 51% | 77% | 93% | — |
| Mw retention after 21 day at 70° C. | % | — | 21% | 37% | — | 101% | 99% |
| Mw retention after 28 day at 70° C. | % | 22% | — | 25% | 74% | 98% | 91% |

The data in Table 6 shows the effect of a carboxy-reactive material on resistance to E85/Gasoline at 70° C. Examples E12-E14 (with a carboxy-reactive material, CoatOSil 1770 or ERL 4221), show substantially higher Mw retention than comparative examples C12-C14.

To generate the data in Table 7, ASTM Type I Tensile bars in Fuel CE10 were contained in closed pressure vessel at 70° C. The molecular weight of PBT in the tensile bars was measured before and after the tensile bars were exposed to fuel.

TABLE 7
Impact modified polyester blend in Fuel CE10 at 70° C.

| Formulation | Unit | C15 | E15 | E16 | E17 | E18 |
|---|---|---|---|---|---|---|
| PBT 315 | % | 75 | 77 | 77 | 39 | 39 |
| PBT 195 | % | — | — | — | 39 | 39 |
| MBS | % | 20 | 20 | 20 | 20 | 20 |
| ADR-4368 | % | — | 1.0 | — | — | |
| CoatOSil 1770 | % | — | — | 1.0 | 1.0 | |
| ERL4221 | % | | | | | 1.5 |
| NaSt | % | — | — | 0.025 | 0.025 | 0.05 |
| TSAN | % | 1.0 | 1.0 | 1.0 | 1.0 | 1.0 |
| Irganox 1010 | % | 0.10 | 0.10 | 0.10 | 0.10 | 0.1 |
| PETS | % | 0.10 | 0.10 | 0.10 | 0.10 | 0.3 |
| Seenox 412S | % | 0.30 | 0.30 | 0.30 | 0.30 | 0.1 |
| Irgophos 168 | % | 0.03 | 0.03 | 0.03 | 0.03 | 0.03 |
| Fuel Resistance | | | | | | |
| Initial Mw | Kg/mol | 71.7 | 80.7 | 85.7 | 106 | 67.6 |
| Mw retention, 7 days | % | 89% | 93% | 93% | 93% | — |
| at 70° C. | | | | | | |
| Mw retention, 14 | % | 82% | 95% | 89% | 90% | 101% |
| days at 70° C. | | | | | | |
| Mw retention, 21 | % | 78% | 92% | 88% | 87% | 104% |
| days at 70° C. | | | | | | |

The data in Table 7 shows the effect of a carboxy-reactive material on resistance to Fuel CE10. Examples E15-E17 (with a carboxy-reactive material, ADR-4368 or CoatOSil 1770) show substantially higher Mw retention than comparative examples C15.

Unless defined otherwise, technical and scientific terms used herein have the same meaning as is commonly understood by one of skill in the art to which this invention belongs. The endpoints of all ranges directed to the same component or property are inclusive and independently combinable.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. An article, comprising a composition comprising the reaction product of a polyester and a carboxy-reactive material, wherein the composition has increased resistance to a component of a liquid fuel relative to the same composition without the reaction product.

2. The article of claim 1, wherein the liquid fuel is gasoline, diesel, ethanol, methanol, or a combination comprising at least one of the foregoing fuels.

3. The article of claim 1, wherein the liquid fuel comprises an alcohol as a component.

4. The article of claim 1, wherein the alcohol is a C₁-C₆ alcohol.

5. The article of claim 1, wherein the liquid fuel comprises 10 to 99 volume % of gasoline and 1 to 99 volume % of a C₁-C₆ alcohol.

6. The article of claim 5, wherein the C₁-C₆ alcohol is methanol, ethanol, or a combination comprising methanol and ethanol.

7. The article of claim 1, wherein the liquid fuel comprises 10 to 90 volume % of regular gasoline and 10 to 90 volume % of a C₁-C₆ alcohol.

8. The article of claim 1, wherein the article is in the form of an injection molded, article.

9. The article of claim 6, wherein the article is in the form of a container for a liquid fuel.

10. The article of claim 4, wherein the liquid fuel is gasoline or diesel, and further comprises a C₁-C₆ alcohol.

11. The article of claim 1, wherein the article is in the form of a fiber.

12. The article of claim 11, wherein the fibers is a component of a nonwoven mat.

13. The article of claim 1, wherein the polyester reaction product retains at least 75% of its initial molecular weight after immersion in a liquid fuel at 70° C. for 14 days.

14. The article of claim 1, wherein the polyester reaction product retains at least 80% of its initial molecular weight after immersion in a liquid fuel at 70° C. for 14 days.

15. The article of claim 1, wherein the polyester reaction product retains at least 90% of its initial molecular weight after immersion in a liquid fuel at 70° C. for 14 days.

16. The article of claim 1, wherein the polyester reaction product, in the form of fibers having a diameter of 1 to 50 micrometers, retains at least 80% of its initial molecular weight after immersion in a mixture of 85 volume % ethanol and 15 volume % regular gasoline for 7 days at 70° C.

17. The article of claim 1, wherein the polyester reaction product, in the form of fibers having a diameter of 1 to 50 micrometers, retains at least 70% of its initial molecular weight after immersion in a mixture of 85 volume % ethanol and 15 volume % regular gasoline for 14 days at 70° C.

18. The article of claim 1, wherein the polyester reaction product, in the form of fibers having a diameter of 1 to 50 micrometers, retains at least 70% of its initial molecular weight after immersion in a mixture of 85 volume % ethanol and 15 volume % regular gasoline for 28 days at 70° C.

19. The article of claim 1, wherein the polyester reaction product in the form of an injection molded article retains at least 70% of its initial molecular weight after immersion in a mixture of 45 volume % toluene, 45 volume % isooctane, and 10 volume % ethanol for 7 days at 70° C.

20. The article of claim 1, wherein the polyester reaction product in the form of an injection molded article, retains at least 90% of its initial molecular weight after immersion in a mixture of 45 volume % toluene, 45 volume % isooctane, and 10 volume % ethanol for 7 days at 70° C.

21. The article of claim 1, wherein the composition further comprises an impact modifier, and wherein the polyester reaction product of the impact-modified composition in the form of an injection molded article retains at least 90% of its initial molecular weight after immersion in a mixture of 45 volume % toluene, 45 volume % isooctane, and 10 volume % ethanol for 7 days at 70° C.

22. The article of claim 1, wherein the composition further comprises an impact modifier, and wherein the polyester reaction product of the impact-modified composition in the form of an injection molded article retains at least 85% of its initial molecular weight after immersion in a mixture of 45 volume % toluene, 45 volume % isooctane, and 10 volume % ethanol for 14 days at 70° C.

23. The article of claim 1, wherein the composition further comprises an impact modifier, and wherein the polyester reaction product of the impact-modified composition in the form of an injection molded article retains at least 80% of its initial molecular weight after immersion in a mixture of 45 volume % toluene, 45 volume % isooctane, and 10 volume % ethanol for 21 days at 70° C.

24. The article of claim 1, wherein the polyester is polybutylene terephthalate, polyethylene terephthalate, a combination of polyethylene naphthalate and polybutylene naphthalate, polytrimethylene terephthalate, polycyclohexane dimethanol terephthalate, polycyclohexane dimethanol terephthalate copolymers with ethylene glycol, or a combination comprising at least one of the foregoing polyesters.

25. The article of claim 1, wherein the polyester is polybutylene terephthalate.

26. The article of claim 1, wherein the carboxy-reactive compound is an epoxy, a carbodiimide, an orthoester, an oxazoline, an oxirane, an aziridine, an anhydride, or a combination comprising at least one of the foregoing epoxy-reactive compounds.

27. The article of claim 1, wherein the carboxy-reactive material is a compound comprising an epoxy group, a compound comprising an epoxy group and a silane group, a copolymer comprising units derived from the reaction of an ethylenically unsaturated compound and glycidyl(meth)acrylate, a terpolymer comprising units derived from the reaction of two different ethylenically unsaturated compounds and glycidyl(meth)acrylate, a styrene-(meth)acrylic copolymer containing a glycidyl group incorporated as a side chain, an oligomer containing a glycidyl group incorporated as a side chain, or a combination comprising at least one of the foregoing carboxy-reactive compounds.

28. The article of claim 1, wherein the carboxy-reactive compound comprises an epoxy group, and the amount of epoxy in the polyester composition is 5 to 320 milliequivalent epoxy group per 1.0 kg of the polyester.

29. The article of claim 1, wherein carboxy-reactive compound is an epoxy silane comprising a terminal epoxy group and a terminal silane group.

30. The article of claim 29, wherein the epoxy silane is beta-(3,4-epoxycyclohexyl)ethyl triethoxysilane.

31. The article of claim 1, wherein the carboxy-reactive material is an epoxy silane, and the amount of epoxy silane reacted with the polyester is 0.1 to 2.0 wt.% of the polyester.

32. The article of claim 1, wherein the carboxy-reactive material is an epoxy compound having at least two terminal epoxy groups.

33. The article of claim 1, wherein the carboxy-reactive material is a dicycloaliphatic diepoxy compound.

34. The article of claim 1, wherein the carboxy-reactive material is 3,4-epoxycyclohexylmethyl-3,4-epoxycyclohexanecarboxylate.

35. The article of claim 1, wherein the carboxy-reactive material is an epoxy-functional polymer.

36. The article of claim 1, wherein the carboxy-reactive material is a poly(ethylene-glycidyl methacrylate-co-methacrylate).

37. The article of claim 1, wherein the carboxy-reactive material is a poly(ethylene-glycidyl methacrylate-co-methacrylate) and a dicycloaliphatic diepoxy compound.

38. The article of claim 1, wherein the composition further comprises a catalyst for the reaction between the polyester and the carboxy-reactive compound.

39. The article of claim 38, wherein the catalyst is a hydroxide, hydride, amide, carbonate, borate, phosphate, C₂₋₁₈ enolate, C₂₋₃₆ dicarboxylate, or C₂₋₃₆ carboxylate of a metal; a Lewis acid catalyst; a C₁₋₃₆ tetraalkyl ammonium hydroxide or acetate; a C₁₋₃₆ tetraalkyl phosphonium hydroxide or acetate; an alkali or alkaline earth metal salt of a negatively charged polymer; or a combination comprising at least one of the foregoing catalysts.

40. The article of claim 38, wherein the catalyst is selected from the group consisting of sodium, potassium, lithium, cesium, calcium, magnesium, barium salt, and mixtures thereof.

41. The article of claim 38, wherein the catalyst is selected from the group consisting of sodium stearate, zinc stearate, sodium carbonate, sodium acetate, sodium bicarbonate, sodium benzoate, sodium caproate, potassium oleate, and a mixture comprising at least one of the foregoing salts.

42. The article of claim 38, wherein the catalyst is a boron compound.

43. The article of claim 1, wherein the composition comprising the reaction product further comprises an impact modifier.

44. The article of claim 43, wherein the impact modifier is a natural rubber, a low-density polyethylene, a high-density polyethylene, a polypropylene, a polystyrene, a polybutadiene, a styrene-butadiene copolymer, an ethylene-propylene copolymer, an ethylene-methyl acrylate copolymer, an ethylene-ethyl acrylate copolymer, an ethylene-vinyl acetate copolymer, an ethylene-glycidyl methacrylate copolymer, a polyethylene terephthalate-poly(tetramethyleneoxide)glycol block copolymer, a polyethylene terephthalate/isophthalate-poly(tetramethyleneoxide)glycol block copolymer, or a combination comprising at least one of the foregoing impact modifiers.

45. The article of claim 43, wherein the impact modifier is a core-shell polymer.

46. The article of claim 43, wherein the impact modifier is present in an amount of 2 to 30 weight % of the total weight of the composition comprising the reaction product.

47. An article, comprising a composition comprising the reaction product of a polybutylene terephthalate ester and an epoxy silane, a dicycloaliphatic diepoxy compound, or a polymeric epoxy compound in the presence of an alkali metal stearate or a boron catalyst, wherein the composition has increased resistance to components of a liquid fuel relative to the same composition without the reaction product.
